(19) United States
(12) Patent Application Publication
(10) Pub. No.: US 2017/0109752 A1
(43) Pub. Date: Apr. 20, 2017

(54) UTILIZING ENHANCED CARDHOLDER AUTHENTICATION TOKEN

(71) Applicant: MasterCard International Incorporated, Purchase, NY (US)

(72) Inventors: Steve Hubbard, Leicester (GB); Sheryl J. Lock, Saint Charles, MO (US)

(21) Appl. No.: 14/883,835

(22) Filed: Oct. 15, 2015

(51) Int. Cl. G06Q 20/40; H04L 29/06; G06Q 20/34

(52) U.S. Cl. CPC G06Q 20/4014; G06Q 20/4016; G06Q 20/34; H04L 63/10

(57) ABSTRACT

Methods and systems for authorizing an online purchase transaction. In some embodiments, during an online transaction a merchant plug-in (MPI) application of a merchant server receives a cardholder authentication message including an enhanced accountholder authentication variable (AAV) from an issuer access control server (ACS). The MPI application then transmits a purchase transaction authorization request message to a payment gateway that includes the enhanced AAV, and receives a purchase transaction authorization response. The merchant server computer displays the purchase transaction authorization response on a merchant webpage and stores it along with the enhanced AAV in association with the cardholder data in an MPI database.

### FIELD OF THE DISCLOSURE

Embodiments described herein generally relate to utilizing an enhanced cardholder authentication token or indicator for Card-Not-Present (CNP) or online transactions. In some embodiments, an enhanced cardholder authentication token is generated using the Secure Protocol Algorithm (SPA) during an online transaction which includes an enhanced cardholder authentication indicator that specifies the method used to authenticate the cardholder. This cardholder authentication method information can be used by merchants and/or issuer financial institutions, for example, to facilitate subsequent or future customer authentication decisions and/or purchase transaction authorization decisions.

### BACKGROUND

Payment cards such as credit or debit cards are ubiquitous, and for decades such cards have included a magnetic stripe on which the relevant account number is stored. Traditionally, to consummate a purchase transaction with such a payment card, the card is swiped through a magnetic stripe reader in a retail store that is part of the point-of-sale (POS) terminal The reader reads the account number from the magnetic stripe, and that account number is then used to electronically route a transaction authorization request that is initiated by the POS terminal through a payment network.

Payment card-based transactions are now typically performed across multiple channels of commerce. For example, payment card-based transactions may be performed in-person at a retail outlet (as described above), via a computer connected to the internet (an online transaction) or other network, via a mobile phone and/or via a company-based call center (e.g., a 1-800 number for a catalog company). These various types of transactions are conducted in different ways, and thus each type of transaction is associated with a different level of fraud risk. In addition, the payment card transactions generally require that the consumer have his or her payment card available to either present to a cashier in a retail environment, or to enter the requested information (such as a sixteen digit payment card account number, an expiration date and a credit card verification value (CVV) number) via a web browser for an online or Internet transaction, and/or to provide requested information over the telephone.

Persons skilled in the field recognize that the risk of fraud is greater for a remote transaction (such as an online or Internet purchase or payment transaction) because there is less ability for a merchant or payee to verify the identity and authenticity of the payer or cardholder. The nature of remote or Internet or online transactions (otherwise known as “Card-Not-Present” (CNP) transactions) therefore increases risk for merchants and for payment card network providers. This increased risk often results in more cardholder disputes and associated chargebacks than occur after in-person purchase or payment transactions, and can also result in lower approval rates because of less trust in transactions that occur with no authentication.

With the advent of e-commerce and m-commerce (mobile commerce), consumers are increasingly using personal computers and/or payment-enabled portable or mobile devices (such as smart phones, tablet computers, personal digital assistants (PDAs), laptops, and/or digital music players) to make CNP purchases via merchant websites over the Internet. Consequently, various techniques have evolved that allow for secure payment for goods and/or services ordered online by consumers or cardholders using their payment card accounts.

Attempts to provide an additional security layer for online credit card and/or debit card transactions have been proposed, and several different protocols have been adopted by payment card networks. For example, the three-domain secure (3-D Secure) protocol was designed as an additional security layer for online credit card and debit card transactions, and it ties the financial authorization process with online authentication based on a three-domain model. The three domains are the acquirer domain (which includes the merchant and the merchant's bank to which money is being paid), the issuer domain (which typically includes the bank that issued the cardholder's or consumer's payment card account), and the interoperability domain (which includes the network infrastructure provided by the payment card scheme or payment services provider, such as a directory service server computer(s) and/or payment network server computer(s), which supports the 3-D Secure protocol).

For example, MasterCard International Incorporated provides the MasterCard SecureCode service, which is a 3-D Secure implementation, and which includes cardholder authentication solutions that utilize a universal standard called universal cardholder authentication field (UCAF). The SecureCode service is used by member (issuer) financial institutions (FI's) such as issuer banks, and also by merchants, merchant FI's and MasterCard to collect and to transmit accountholder authentication data generated by issuer and accountholder security solutions. Thus, the UCAF is designed to be security scheme independent and accordingly offers standardized fields and messages for use by merchants and by MasterCard member financial institutions. Once collected by a merchant and the merchant's acquirer FI, cardholder authentication information is communicated to the issuer FI in the payment authorization request and provides explicit evidence that the transaction (such as a purchase transaction) was originated by the accountholder or cardholder. The UCAF supports a variety of issuer security and authentication approaches, including use of the Secure Protocol Algorithm (SPA), issuer servers, smart cards and more. In some implementations, the token generated by the SPA includes a basic indication (or at least some evidence) that cardholder authentication occurred.

Payment networks conventionally utilize similar services that are generally based on the 3-D Secure protocol, and each of these services adds an additional cardholder authentication process to the standard financial authorization process. However, conventional authentication schemes for online or Internet transactions typically provide only very limited information to issuer financial institutions and/or to merchants regarding how a particular cardholder was authenticated. Thus, in order to improve the cardholder experience while also increasing the ability to detect and/or prevent fraud, it would be desirable to provide enhanced cardholder authentication information to issuer FI's and merchants.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate exemplary embodiments and which are not necessarily drawn to scale, wherein:

FIG. 1 is a block diagram of a transaction system to illustrate a conventional 3-D Secure authentication process;

FIG. 2 is a block diagram of a purchase transaction system illustrating the flow of cardholder authentication data in accordance with novel processes of the disclosure;

FIG. 3 is a table illustrating an example of a format for a Secure Protocol Algorithm (SPA) enhanced accountholder authentication variable (AAV) control byte and for authentication method and description fields in accordance with processes of the disclosure;

FIG. 4 is a flowchart illustrating a merchant purchase transaction method in accordance with embodiments of the disclosure; and

FIG. 5 is a flowchart illustrating an issuer financial institution purchase transaction authorization method in accordance with an embodiment of the disclosure.

### DETAILED DESCRIPTION

In general, and for the purpose of introducing concepts of novel embodiments described herein, described are systems and processes for providing enhanced consumer authentication data or information to issuer financial institutions (FIs) and/or to merchants during processing of online purchase transactions. In some embodiments, an authentication token generated by the Secure Protocol Algorithm (SPA) during such online transactions or Internet transactions (also known as Card-Not-Present (CNP) transactions) is modified to provide an enhanced cardholder authentication indicator. It is contemplated, however, that an enhanced cardholder authentication indicator or token may be generated by another type of algorithm (other than the SPA) for use in accordance with methods, apparatus and systems described herein. The enhanced cardholder authentication indicator provides enhanced or improved or additional information that indicates how a cardholder was authenticated for a particular transaction, and this information can then be stored and utilized by merchants and/or by issuer FIs to make subsequent or future customer authentication and/or purchase authorization decisions.

A number of terms will be used herein. The use of such terms are not intended to be limiting, but rather are used for convenience and ease of exposition. For example, as used herein, the term “cardholder” may be used interchangeably with the term “consumer” and are used herein to refer to a consumer, person, individual, business or other entity that owns (or is authorized to use) a financial account such as a payment card account (such as a credit card account or debit card account). In addition, the term “payment card account” may include a credit card account, a debit card account, a loyalty card account, and/or a deposit account or other type of financial account that an account holder or cardholder may access or utilize for transactions. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment system” and/or “payment network” refer to a system and/or network for processing and/or handling purchase transactions and/or related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other entities or organizations. In addition, the terms “payment system transaction data” and/or “payment network transaction data” or “payment card transaction data” or “payment card network transaction data” refer to transaction data associated with payment transactions and/or purchase transactions that have been processed over a payment network or payment system. For example, payment system transaction data may include a number of data records associated with individual payment transactions (or purchase transactions) of consumers that have been processed over a payment card system or payment card network. In some embodiments, payment system transaction data may include information that identifies a cardholder, a cardholder's payment device or payment account, a transaction date and time, a transaction amount, merchandise or services that have been purchased, and information identifying a merchant and/or a merchant category. Additional transaction details may also be available in some embodiments.

Reference will now be made in detail to various novel embodiments and/or implementations, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

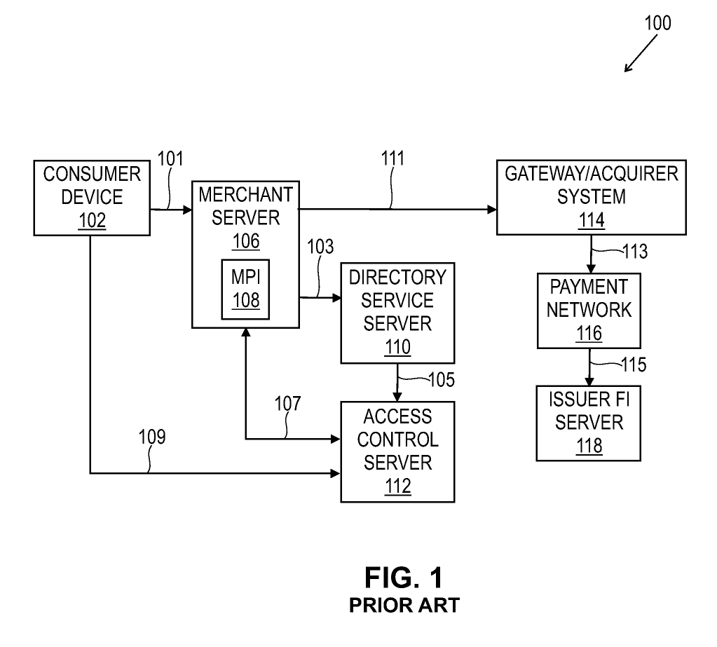

FIG. 1 is a block diagram of a conventional transaction system 100 to illustrate an example of a 3-D Secure protocol or authentication service. The authentication service provides an authentication process that typically involves a number of participants and messages in order to authenticate a cardholder for a transaction. In order to use the authentication service, a consumer or cardholder must first enroll or register, typically by visiting an issuer financial institution (FI) enrollment website (such as the website of an issuer bank) and provide issuer enrollment data to prove his or her identity. If the appropriate answers are provided, the cardholder is considered authenticated and is permitted to establish a private code to be associated with his or her payment card account number and/or primary account number (PAN) (which is associated with, for example, a credit card account or a debit card account). The private code is associated with the cardholder's payment card account and is stored by the issuer FI for later or subsequent use during online purchases at participating merchant websites.

Referring to FIG. 1, a cardholder desiring to purchase goods and/or services over the Internet (online) operates a consumer device 102, which may be a personal computer or a mobile device (such as a smartphone, tablet computer, laptop, digital music player, and the like), and uses an Internet browser (not shown) to contact a merchant server computer 106 to shop at a merchant's website. In some implementations, the merchant server 106 includes a merchant plug-in (“MPI”) application 108, which will be explained below. After selecting merchandise and/or services and adding those items to the merchant's electronic “checkout cart” webpage, to initiate the purchase transaction, the cardholder provides payment card account information (which may include a primary account number (“PAN”), an expiration date, a cardholder verification value (or “CVV” value), billing address information, and the like). The payment card account data is then typically transmitted over a secure socket layer (“SSL”) connection 101 from the cardholder's computer 102 to the merchant's server computer 106.

The merchant website server computer 106 receives the data provided by the consumer via the SSL connection 101, and the merchant plug-in (MPI) application 108 then generates and sends a verification request message and a verification response message via a SSL connection 103 to a Directory Service server computer 110 (for example, the Directory Service server computer 110 may be the MasterCardTM Directory service operated by MasterCard International Incorporated). In some implementations, the Directory Service server computer 110 uses a bank identification number (BIN), which is part of the cardholder's PAN, to check payment card range eligibility for the authentication service and to identify the relevant issuer financial institution (FI). If the specified PAN is in the eligible payment card range for the authentication service, then the data is transmitted via another SSL connection 105 to an issuer access control server (ACS) 112, which determines whether or not the specific account number is enrolled and is active to participate in the authentication service. If the cardholder is enrolled as a participant, the issuer ACS 112 establishes a secure session via connection 107 with the merchant server computer 106, and the MPI 108 creates a payer authentication request message which is transmitted back to the ACS 112 via the secure session via connection 107. When the ACS 112 receives the payer authentication request message, it causes an authentication dialog to begin via a connection 109 with the consumer device 102. In some embodiments, the authentication dialog includes causing a separate authentication window to appear in the cardholder's browser running on the cardholder's device (which may be, for example, a consumer mobile device such as a smartphone). The authentication window, which is typically presented on a display screen of the consumer device 102 during the consumer's checkout process, prompts the cardholder to enter his or her private code. At this point in the process, the consumer enters the private code and the cardholder's browser then redirects or transmits the private code information via the connection 109 to the ACS 112 for authentication. If the private code is correct or matches the stored private code associated with the cardholder, then the ACS 112 authenticates the cardholder and generates an accountholder authentication variable (“AAV”). The AAV is then transmitted by the ACS 112 via the connection 107 to the MPI 108 of the merchant server 106, and the cardholder authentication window on the display screen of the consumer device 102 disappears.

The AAV is a token that is generated using the MasterCard™ Secure Protocol Algorithm (SPA). This token is passed in the universal cardholder authentication field (UCAF) for transport within the authorization message. The UCAF is used to communicate authentication information amongst various stakeholders in a transaction (i.e., the issuer FI and/or the merchant). Accordingly, at this point in the process, the cardholder has been authenticated using a 3-D Secure protocol and the merchant server 106 transmits the AAV via connection 111 to a gateway/acquirer system 114 as part of a purchase authorization request. Next, the gateway/acquirer system 114 submits the purchase authorization request via a secure connection 113 to a payment network 116, which forwards 115 the authorization request message to the appropriate issuer server computer 118 for purchase transaction authorization processing. In particular, the issuer FI 118 utilizes the information in the received authorization request to make a determination whether or not to authorize the purchase transaction for that cardholder. For example, the issuer FI may utilize one or more authorization criteria and/or business rules to determine when a particular purchase transaction should be authorized or should be denied. For example, the issuer FI may authorize the transaction and generate an authorization response message if the following are true: the transaction amount is below a predetermined limit, the cardholder has been authenticated via the authentication service process, and the cardholder's credit card account has an adequate credit line to cover the cost for the purchase transaction (of course, other business rules and/or criteria could also be utilized by the issuer FI).

When the online purchase transaction is authorized, the issuer FI transmits via connection 115 a purchase transaction authorization response message to the payment network 114, which forwards it to the merchant's acquirer financial institution (not shown) for payment. The payment network 114 also transmits the transaction authorization response message via connection 113 to the gateway system 114 to forward via connection 111 to the merchant server 104 to consummate the purchase transaction. Thus, upon receipt of the purchase transaction authorization, the merchant conventionally transmits a purchase consummation message to the consumer device and/or displays a purchase confirmation message on the merchant's checkout webpage to notify the cardholder that the purchase has been consummated. Such 3-D Secure authentication processes were designed to provide a greater level of cardholder authentication during remote or online transactions and to reduce “unauthorized transaction” chargebacks for merchants.

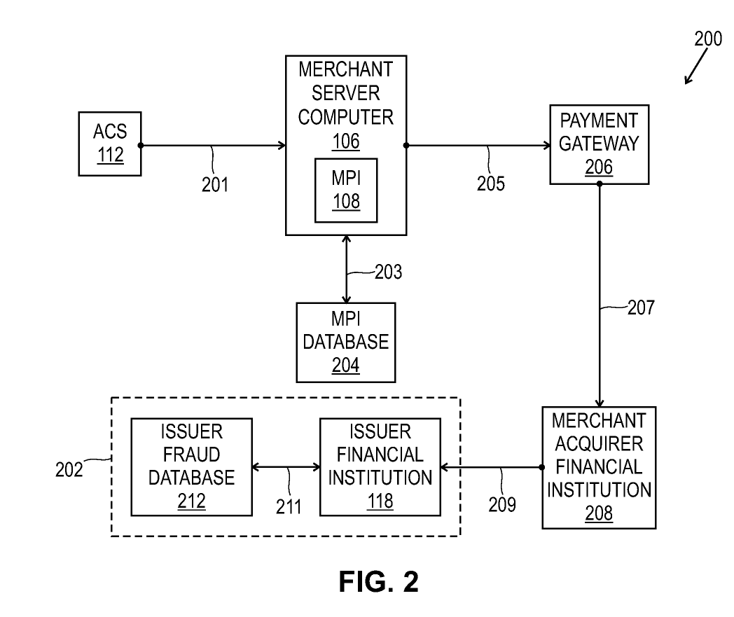

FIG. 2 is a block diagram of a purchase transaction system 200 to illustrate the flow of cardholder authentication data in accordance with novel processes described herein. In particular, the flow of cardholder authentication data from an Access Control Server (ACS) 112, which can be hosted by a third party payment service provider (PSP), to the issuer's back office system 202 will be described. It should be understood that a third party PSP is responsible for authenticating cardholders on behalf of issuer FI's, and typically implements a cardholder authentication scheme or process as dictated by that cardholder's issuer FI (in accordance with authentication rules and/or authentication criteria required by the issuer FI). It should also be understood that some of the various components shown in FIG. 2 may be a subset of a larger system or systems, and/or that more or less components and/or devices may be utilized. For example, although only one merchant server 106, one payment gateway server computer 206, one merchant acquirer server computer 208, and one issuer FI server computer 118 are shown, in practical embodiments a plurality of such components may be utilized. In addition, one or more of the components shown in FIG. 2 may be a special purpose computer configured to function in accordance with one or more processes described herein.

Although specific embodiments are described herein, it should be understood that FIG. 2 is presented for illustrative purposes only and that different components and/or configurations could be used without departing from the spirit and scope of this disclosure. Thus, in accordance with a 3-D Secure protocol (and in some cases in response to the cardholder providing requested cardholder identification data) the ACS 112 of the purchase transaction system 200 is configured to generate an enhanced accountholder authentication variable (an enhanced “AAV”) using the SPA that includes enhanced or improved authentication indicators as proof of authentication. In particular, as part of the AAV, a control byte field at position one (Byte 1) of the UCAF (explained in detail below) is used to indicate the disposition of the authentication in conjunction with the authentication method utilized for the transaction.

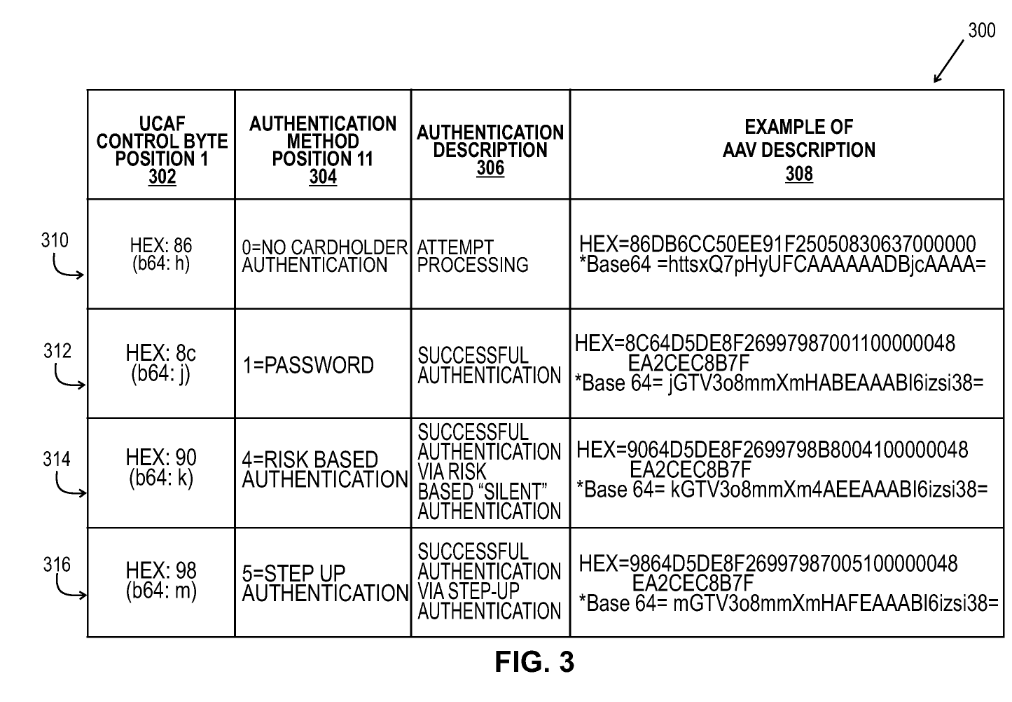

FIG. 3 depicts a table 300 illustrating a format for enhanced SPA AAV control byte and authentication method fields in accordance with the processes disclosed herein. The table 300 includes a UCAF control byte (Position 1) column 302, an Authentication Method (Position 11) column 304, an Authentication Description column 306, and an Example of AAV Description column 308 (wherein, in some embodiments, the AAV will be in the hexadecimal or “Hex” format and/or the “Base 64”format). As mentioned earlier, different types of 3-D Secure techniques are currently in use. In an example embodiment, a hexadecimal value of “86” in Byte 1 of the UCAF, ora Base 64 value of “h” (see column 302 of row 310), and a zero (“0”) in position 11 (or Byte 11) of the UCAF (see column 304 of row 310) provides an authentication method indication that the cardholder was not authenticated to the issuer's ACS using attempt processing (column 306 of row 310). In particular, since in row 310 a value of zero (“0”) appears at Byte 11 (see column 304; which is only valid for a control byte value of “86”) then cardholder authentication was not obtained. In this case, the AAV is generated in either Hexadecimal format or Base64 format (see column 308 of row 310) as shown.

However, as shown in FIG. 3, if a hexadecimal value of “8C” is provided in

Byte 1 of the UCAF, or a Base64 value of “j” (see column 302 and row 312), and a value of one (“1”) appears at Byte 11 (see row 312 and column 304) then a password was successfully provided by the cardholder (which was validated by the issuer ACS). This means that a successful cardholder authentication occurred (see column 306 of row 312), and thus the AAV is generated to indicate a successful cardholder authentication in either Hexadecimal format or Base64 format as shown (see column 308 of row 312). Such AAV data can be utilized, for example, by the issuer FI when making a determination of whether or not to authorize a particular purchase transaction of the cardholder, but otherwise provides very little information to the issuer FI or to the merchant regarding how the cardholder was authenticated for a particular transaction.

In accordance with novel aspects of the present disclosure, a combination of new values are added to the AAV Control Byte field 302 (UCAF position 1) and to the Authentication method field 304 (UCAF position 11) to provide improved and/or enhanced AAV information that can be utilized by issuer FIs and/or merchants to make improved authentication and/or authorization decisions which can advantageously improve the customer or consumer shopping experience and improve issuer FI and/or merchant fraud prevention practices. For example, the enhanced AAV values may allow merchants and/or issuer FIs to identify risk-based authentication situations or events and the like during an online purchase transaction, and to then take appropriate action(s). Such enhanced authentication information or data could be utilized, for example, by a merchant to build a database, such as the MPI database 204 of FIG. 2, which includes associations between a particular type or types of authentication method(s) and particular issuer FIs. Then, during future or subsequent purchase transactions, a merchant can choose to bypass the cardholder authentication process for a cardholder of a particular or specific or identified issuer FI (for example, because the database includes an entry indicating that a particular issuer FI utilizes a secure authentication method) to provide a good consumer experience. Merchants can also include undesirable cardholder authentication process information that may be associated with one or more issuer FIs in the merchant database, and use this information or data to then require cardholder authentication to occur for a transaction because of the increased risk involved. Accordingly, merchants can utilize the enhanced and/or additional authentication information or data to control the consumer purchase transaction experience by leveraging the benefits of authentication only for those cardholders associated with issuer FIs that provide the best consumer experience (and conversely avoid authentication of cardholders associated with issuer FIs having undesired authentication solutions).

Referring again to FIG. 3, in some embodiments the issuer ACS is configured to generate the AAV using the SPA with enhanced values as proof of authentication so that, as part of the AAV, the UCAF control byte field 302 may now includes a hexadecimal “90” indicator (see row 314), or Base64 value of “k,” and the Authentication Method field 304 (Byte 11) includes a value of “4” (row 314, column 304) to indicate that a “risk-based authentication” occurred. In particular, as shown by the Authentication Description column 306 for row 314, this means that a successful authentication via a risk-based “silent” authentication occurred, which means that the cardholder is unaware that he or she has been authenticated based on risk criteria (for example, the cardholder was not asked for any additional information, such as a password, due to the fact that he or she was recognized as a loyal customer, and perhaps because the purchase transaction value or monetary amount was also below a predetermined threshold amount).

Referring again to FIG. 3, another example of an enhanced value in the UCAF control byte field 302 is shown as a hexadecimal indicator “98” entry (see row 316, column 302), or Base64 value of “m,” and the Authentication Method field 304 (Byte 11) includes a value of “5” (row 316, column 304) to indicate that a “Step-up authentication” occurred. In this case, as shown by the Authentication Description column 306 for row 316, this means that a successful authentication via a Step-up authentication occurred, for example, because the purchase transaction was considered to be a “high-risk” transaction requiring the cardholder to provide some additional type of authentication information, which was successfully provided.

At this point in the disclosure, it may be instructive to describe the different types of cardholder authentication methods that could be utilized to authenticate a cardholder engaged in a purchase transaction. Some cardholder authentication methods rely on a static password, wherein a cardholder is prompted immediately after initiating a purchase transaction to provide a static password to authenticate himself or herself, which may occur for every eligible transaction, and which password may be defined by the cardholder or randomly assigned by the payment card issuer. Another form of cardholder authentication method is known as “knowledge based” authentication, wherein the cardholder is prompted to authenticate for every eligible purchase transaction by providing answers to a randomly selected security question based upon static data, or prompted to select a correct answer based upon historical banking data (or other personal data associated with the consumer or the cardholder's accounts). Yet another type of cardholder authentication method includes the use of a one-time password, wherein the cardholder is prompted to authenticate for every eligible transaction using a one-time password that had been provided earlier and that is only valid for one transaction and has an expiration date. Such one-time passwords can be generated by an issuer FI and then transmitted, for example, to a consumer's mobile device via an SMS message. In particular, the one-time password can be provided via a mobile device application, by a display card, by a chip and pin card reader, or via a key fob, secure token and/or software token prior to the cardholder entering into any purchase transactions. In some embodiments, cardholder authentication may include the use of biometric data, wherein a cardholder is prompted to authenticate for a particular purchase transaction by using one or more components of a consumer device to provide biometric data such as, but not limited to, behavioral data (for example, stride or walking data), a signature, a fingerprint, an iris scan, a typing pattern, a finger swipe pattern, a speech pattern, and/or photograph data or picture data (for facial recognition processing or the like).

Another type of cardholder authentication process is known as “Risk-based” authentication, wherein the issuer financial institution (FI) chooses when to refrain from prompting a particular cardholder for authentication data. For example, the issuer FI may not require the cardholder to provide any authentication data because of recognition of one or more of a cardholder Internet Protocol (IP) address, a machine finger print, a device address, browser information, a purchase amount, merchant information, geographic location data, transaction history data, and the like. In a risk-based authentication scenario, a particular data point can be used alone or in combination with another data point in accordance with, for example, a risk assignment application. In another example, the issuer FI can choose to “transparently” or “silently” authenticate the cardholder for transactions that are deemed to be “low risk.” This means that the merchant receives a fully authenticated token, and the cardholder is not prompted to enter anything else in order to be authenticated.

Under some circumstances, an issuer FI can also choose to “Step-up” the authentication when the transaction is deemed to be “high risk” or “higher risk.” The Step-up process may include utilizing one or more of any of the above authentication methods. For example, with regard to a particular “high risk” transaction, the cardholder may be prompted to provide two or more forms of cardholder authentication information (such as a static password and/or a knowledge-based identifier, and/or a one-time password, and/or biometric data) in order to be authenticated. It should be understood that each issuer FI may develop rules or protocols or criteria that define what constitutes a “low risk” and/or a “high risk” and/or “higher risk” transaction in accordance with their own internal processes and/or procedures. For example, a particular issuer FI may deem all transactions for cardholders of a particular type of credit card product that involve the purchase of merchandise below thirty dollars ($30.00) to be “low risk,” all transactions for such cardholders of merchandise above two hundred dollars ($200.00) to be “high risk,” and transactions for such cardholders of merchandise above five hundred dollars ($500.00) to be “higher risk.” It should be understood that data factors other than transaction amounts (such as a device address, transaction velocity, delivery address and the like) may also be utilized to build a risk factor for consideration when determining whether or not to use step-up authentication.

Referring again to FIG. 2, as mentioned above, the purchase transaction system 200 illustrates the flow of authentication data from an Issuer's Access Control Server (ACS) 112 to the merchant's server computer 106 and merchant plug-in 108, and onto the Issuer's back office systems 202. In particular, in an embodiment the Issuer's ACS 112 generates the AAV using the SPA with enhanced values (as proof of authentication). However, it should be understood that an enhanced AAV or enhanced cardholder authentication token may be generated by another type of algorithm (other than the SPA) for use in accordance with methods, apparatus and systems described herein. As explained earlier, the control byte field of the UCAF indicates the format and content of the AAV structure, including which authentication method was utilized for the transaction. During purchase transaction processing, the AAV is transmitted 201 to the merchant plug-in 108 of the merchant server computer 106 as proof of cardholder authentication, and in some embodiments the merchant server stores 203 the indication of the type of cardholder authentication that was utilized for that transaction in an MPI database 204.

In some implementations, a merchant may store the type of cardholder authentication used for a plurality of purchase transactions by a plurality of cardholders. The cardholder authentication types may be stored by payment card account range in a transaction database, and this data or information can then be used by a merchant for future or subsequent cardholder purchase transaction events, and can be utilized to bypass consumer authentication (via risk-based cardholder authentication) to improve the consumer experience. For example, the merchant may store information in the MPI database 204 (or another database, such as a purchase transaction database) based upon the AAV values in order to determine, during one or more subsequent purchase transactions involving the same cardholder (or similar cardholders, or cardholders of a particular issuer FI), when to bypass the cardholder authentication process and just submit the purchase transaction to a payment gateway for transaction authorization processing. Thus, the merchant can build a cardholder transaction database that could be used to determine, for particular cardholders, when to send a transaction authorization request to an issuer FI that has a silent authentication process in place (for example, for transactions less than fifty dollars ($50.00) and/or for cardholders using a device from a particular internet protocol (IP) address). The transaction database could also be used by the merchant server computer to determine when to bypass a cardholder authentication process for a particular cardholder or group of cardholders, which determination may be based on past transaction history data and/or based on the type of cardholder authentication utilized by one or more issuer FIs.

In another example, the merchant can utilize information in the merchant database to avoid all issuer FIs that have undesirable authentication processes in place, such as static password authentication processes or a high rate of step-up prompts, by bypassing the cardholder authentication process. In some embodiments, a merchant may choose to drop out of the authentication process if the authentication solution is deemed to provide a poor consumer experience that could potentially lead to abandonment by the cardholder. The transaction database therefore could be used by a merchant for various and/or different purposes. For example, a merchant may utilize information in the transaction database to provide a good consumer experience, and/or to determine when to send for cardholder authentication (for example, high risk transactions that may be defined as purchase transactions having a money value greater than a predetermined threshold, such as transactions for greater than two hundred and fifty dollars ($250.00)). The criteria involved in making such cardholder authentication determinations may also include information concerning a particular cardholder, or information regarding a class of cardholders and/or other types of data. Furthermore, the transaction database entries could also be used by the merchant to determine when to bypass cardholder authentication (for example, when an issuer FI utilizes silent authentication) and transmit a transaction authorization request to a payment gateway, and/or to require another type of consumer authentication based on predetermined criteria. Yet further, the merchant can use the transaction database to determine when or if to update and/or change any criteria for an authentication rules engine, which is used to provide rules that govern when and/or if a particular type of authentication (or particular combinations of authentication) should be utilized for particular types of transactions and/or cardholders. Thus, the merchant can utilize the enhanced data as input to an authentication rules engine to determine cardholder experience (i.e., step-up versus a silent authentication and the like).

Referring again to FIG. 2, the merchant server computer 106 also transmits 205 the AAV value to a payment gateway 206 (which may include one or more payment networks and/or additional components), which then transmits 207 the AAV value to the merchant acquirer financial institution (FI) computer 208. The merchant acquirer FI computer 208 submits 209 the authorization request which contains the original AAV value to the issuer FI computer 118. Thus, the issuer FI 118 computer receives the request for authorization which contains the AAV value that was generated by its own ACS (the issuer ACS 112) during the authentication process. The issuer FI 118 computer can then store 211 the AAV value in an issuer fraud and reporting database 212. When the issuer FI computer 118 is subsequently notified of fraudulent activity that has occurred with regard to a particular transaction or transactions, the issuer FI computer 118 can then match those reported fraud cases with the cardholder authentication solution(s) that was or that were used. The issuer FI computer 118 may then be configured to update the authentication rules engine in an effort to protect against future occurrences of the same type of fraud concerning the same cardholder or class of cardholders. Thus, the issuer FI computer 118 may transmit new or updated rules to the issuer ACS 112 to use for subsequent or future cardholder authorization decisions.

In some embodiments, after fraudulent activity has been identified in relation to a particular cardholder account, a subsequent purchase transaction involving that cardholder account may require Step-up authentication instead of a pure risk-based authentication, thus requiring more information from the cardholder in order for the issuer to authenticate the cardholder. Thus, for such a “high risk” transaction, the issuer FI may be more likely to trust a cardholder authentication process that has been stepped-up. Furthermore, issuer FIs may utilize the data in the issuer fraud database 212 to validate actual fraud rates against their authentication solution(s) performance. Thus, if the fraud rate is found to be high on purchase transactions that passed a risk tolerance threshold (for example, for transparent or silent authentication), the issuer FI may use that information to refine the risk tolerance level or levels (for example, increase the risk tolerance threshold for a certain class of cardholders). In another example, if fraud rates are high on stepped-up authentication events (or for any type of enhanced data solution) then the issuer FI may need to re-examine the step-up method and/or criteria for vulnerabilities and correct them.

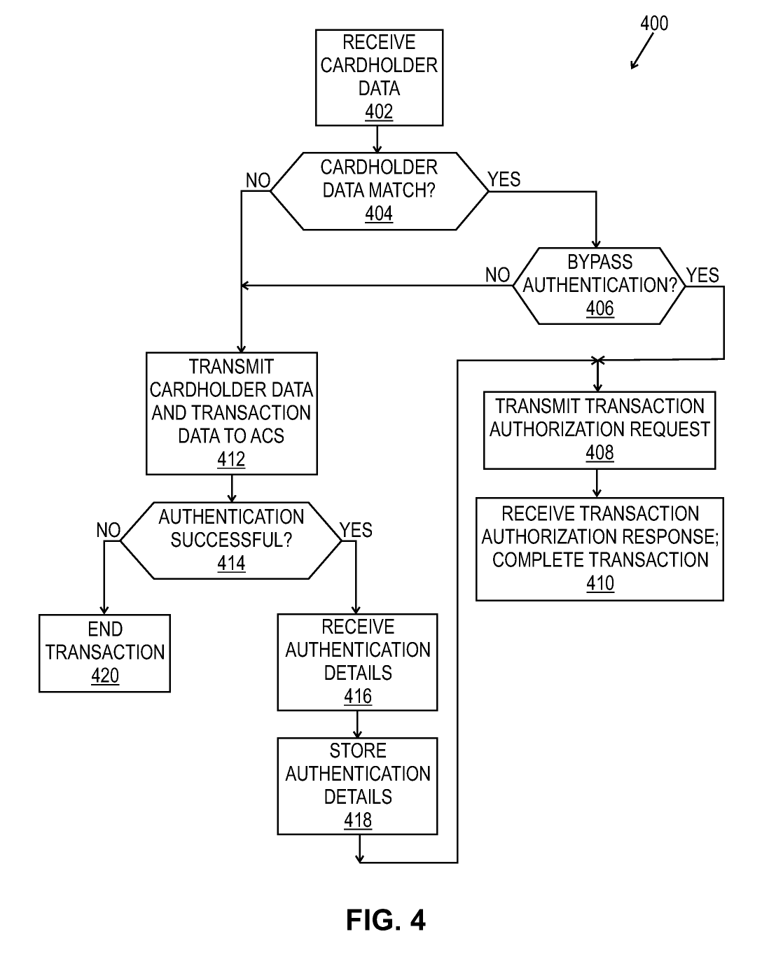

FIG. 4 is a flowchart 400 illustrating a merchant purchase transaction method in accordance with embodiments of the disclosure. A merchant plug-in (MPI) application of a merchant server computer receives 402 cardholder information regarding a purchase transaction from a merchant website checkout page, and then compares 404 the cardholder information to cardholder data in an MPI database. In some implementations, the MPI database contains various types of cardholder purchase transaction history data including, but not limited to, a history of cardholder authentication methods, cardholder identification data of a plurality of cardholders, cardholder authentication results, and purchase transaction amounts. The data stored in the MPI database may be organized by issuer financial institution account range or the like, and can be can be utilized by the merchant server computer to predict a cardholder authentication experience for a particular cardholder with regard to a current purchase transaction. Referring again to step 404, if a cardholder data match occurs, then the MPI determines 406 whether or not to bypass cardholder authentication.

In step 406, the decision regarding whether or not to bypass cardholder authentication may be based on previous experience(s) by the merchant with that cardholder or that type of cardholder (i.e., past purchase transactions), and thus can be based on merchant criteria and/or business rules as applied to the current purchase transaction data. For example, based on the current purchase transaction data (for example, a list of item(s) being purchased, and a total transaction cost) and the cardholder's purchase transaction history data (related to past purchases, which may include similar items), the merchant server computer can predict with a high degree of confidence that the cardholder is valid and/or authentic. In this situation, the merchant can elect to bypass the cardholder authentication process to speed up transaction processing, which results in a good customer experience. For example, the MPI may determine that an enhanced AAV authentication indicator for a similar purchase transaction associated with the cardholder indicates that the current purchase transaction is low-risk (for example, the AAV authentication indicator shows that the cardholder has been authenticated in the past via a risk-based authentication process and no fraud occurred). Since the current purchase transaction represents a low-risk situation, the MPI can elect to bypass cardholder authentication for the current purchase transaction or choose to send for authentication because the likelihood of silent authentication is high and thus the cardholder will not be interrupted and/or inconvenienced.

Referring again to FIG. 4, if a decision is made to bypass cardholder authentication, then the merchant server computer transmits 408 a transaction authorization request that includes the purchase transaction details (i.e., a merchant identifier, cardholder data, purchase transaction data and the like) to a payment gateway. Next, the merchant server computer receives 410 an authorization response from the payment gateway which indicates either that the purchase transaction has been authorized or has been declined by the issuer FI. The merchant server computer then completes the current purchase transaction (for example, for an online transaction the merchant server computer may display a purchase transaction confirmation message on a merchant checkout webpage, and/or may transmit a purchase transaction confirmation message to a consumer device of the consumer indicating an authorization of the purchase transaction. In other cases, the merchant server computer may display a transaction denied message on the merchant webpage and/or may transmit such a transaction denied message to the consumer's device when the issuer FI declined the transaction). In some embodiments, the MPI may also store the current purchase transaction data (including whether the current purchase transaction was authorized or denied) in the MPI database in association with cardholder data. This information may be used by the merchant, for example, to develop a risk approach to online cardholder authentication for use in making determinations concerning when to bypass particular transactions that would otherwise likely be abandoned by certain cardholders.

Referring again to step 404, if the cardholder information regarding a purchase transaction from a merchant website checkout page does not match cardholder data stored in the MPI database (thus indicating a new customer or new cardholder account having no purchase transaction history with the merchant), or if in step 406 the MPI decides not to bypass cardholder authentication for a purchase transaction concerning a cardholder who is in the MPI database, then the MPI transmits 412 the cardholder data and purchase transaction data to an access control server (ACS) for authentication processing. With regard to step 406, the MPI may decide to proceed with cardholder authentication processing for a known cardholder account for a number of reasons. For example, the data of the current purchase transaction may not satisfy one or more business rules and/or merchant criteria. Thus, the MPI may determine that cardholder authentication of a known cardholder should proceed because the current transaction data is out of the ordinary or otherwise inconsistent with prior cardholder purchase data (i.e., the current purchase transaction includes one or more high cost items and/or is being made from an unrecognized IP address), and/or because of reported prior instances of fraud associated with the cardholder's account, and/or because the merchant knows that the authentication experience will be acceptable.

Referring again to FIG. 4, after transmitting the cardholder data and purchase transaction data to an access control server (ACS) for authentication processing in step 412, the MPI receives 414 from the ACS either a cardholder authentication message or a message that authentication failed. When the cardholder authentication fails, the purchase transaction is terminated 420, which in some cases includes the MPI generating and displaying a “transaction declined” message on the checkout webpage to the cardholder (or otherwise communicating a purchase transaction declined message to the cardholder). Referring again to step 414, when the cardholder authentication process is successful, the MPI receives 416 cardholder authentication details from the ACS, which include an enhanced accountholder authentication variable (AAV) that indicates the type of cardholder authentication process that was utilized. It should be understood that, in some cases a third party payment service provider (PSP) hosts the ACS for one or more issuer financial institutions (FIs), and the ACS thus operates to authenticate cardholders on behalf of the one or more issuer FIs. In some implementations, the ACS may communicate with the cardholder to obtain one or more required forms of identification data (such as biometric data, personal identification number (PIN), and/or secret code data), which requirements may be based on one or more factors in accordance with, for example, business rules of a particular issuer FI. For example, a step-up authentication process may be required that requires the cardholder to provide two or more forms of cardholder identification data in accordance with business rules and/or authentication criteria when, for example, a current purchase transaction includes certain predefined data (such as a total transaction amount in excess of a predetermined threshold amount, such as $250.00). In such a case, the cardholder may be prompted to utilize one or more biometric sensors and/or a touch screen and/or other input component associated with his or her electronic device to input the required authentication data (i.e., a voice print, iris scan, fingerprint, or the like) and/or any other authentication data for method(s) the issuer utilizes such as use of one time passwords via SMS messaging, mobile tokens, and the like, which is then transmitted to the ACS for processing. The MPI then stores 418 the cardholder authentication data, which may include data such as cardholder identification data, issuer FI identification data, purchase transaction data associated with the current purchase transaction including the date of the transaction, and the authentication indicator (the enhanced AAV), in the MPI database. The merchant server computer then transmits 408 a purchase transaction authorization request message which includes the enhanced AAV to the payment gateway server computer for purchase transaction authorization processing. Next, as explained above, the merchant server computer receives 410 an authorization response from the payment gateway which indicates either that the purchase transaction has been authorized or has been declined by the issuer FI. The merchant server computer then completes the transaction (for example, the merchant server computer may transmit a transaction confirmation message to the consumer indicating authorization of the purchase transaction, or may transmit a transaction denied message when the issuer FI declined the transaction) and the process ends.

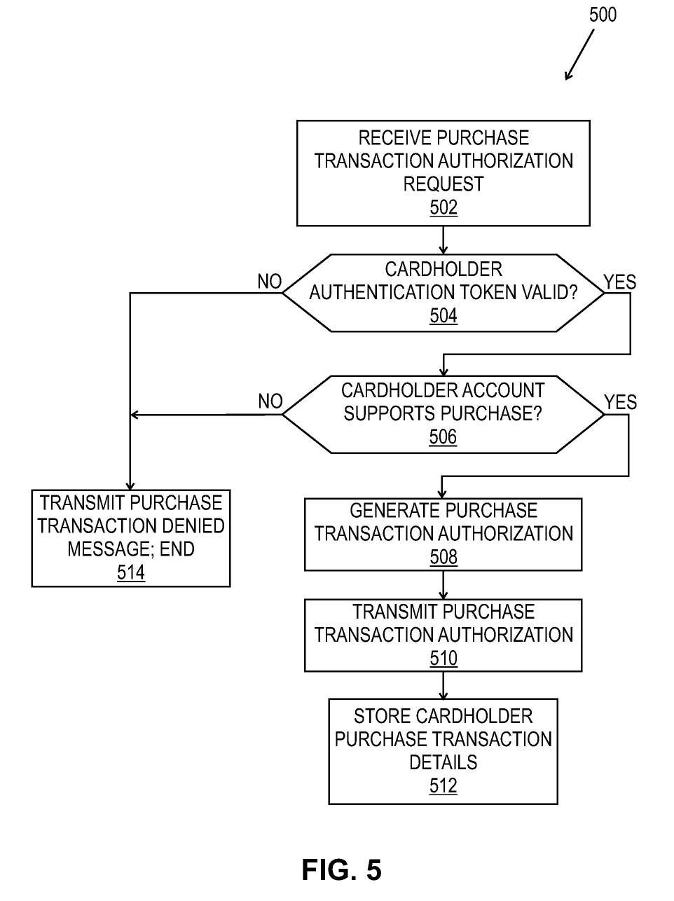

FIG. 5 is a flowchart 500 illustrating a purchase transaction authorization method in accordance with an embodiment of the disclosure. An issuer financial institution (FI) computer receives 502 from a payment system gateway, a purchase transaction authorization request message that includes an enhanced accountholder authentication variable (AAV) or cardholder authentication token containing information in accordance with, for example, the table shown in FIG. 3. In some implementations, the issuer FI computer determines 504 that the cardholder authentication token is valid as generated by the ACS (which is the enhanced AAV), and determines 506 that the cardholder's payment card account supports the current purchase transaction (i.e., has adequate credit to cover the purchase transaction price). The issuer FI next generates 508 a purchase transaction authorization response message and transmits 510 the purchase transaction authorization response message to the payment gateway for routing to the merchant server computer to consummate the purchase transaction. In addition, the issuer FI stores 512 the purchase transaction details (including the enhanced AAV or cardholder authentication token which indicates the type of cardholder authentication utilized) in a purchase transaction database. The issuer FI can utilize such information at a later time or subsequently to determine if it appears that the cardholder account is being used fraudulently. Such data can also be utilized by the issuer FI to update and/or to change the type of cardholder authentication method used in association with that cardholder account and/or for similar cardholder accounts with regard to future purchase transactions. Since the cardholder authentication occurs separately from the issuer FI authorization system, the issuer can utilize the enhanced AAV data to determine if the transaction was a pure risk-based authentication result (i.e., silent authentication) or if the cardholder was actually prompted and passed validation. Such information can help the issuer FI to approve more transactions.

Referring again to FIG. 5, in step 504 the type of cardholder authentication indicated by the enhanced AAV may help the issuer FI decide whether to approve or decline an authorization request that is “on the fence” because the issuer FI knows how the cardholder was authenticated, for example, via a pure risk-based or stepped-up process. In some cases, the issuer FI transmits 514 a purchase transaction denied message to the payment gateway for routing to the merchant server computer. This may occur, for example, when the issuer FI has been notified by the cardholder of a lost or stolen credit card or debit card (and thus the type of cardholder authentication used is not relevant), and/or if the issuer FI has determined that it is likely that fraud is occurring in that cardholder account. In such cases, the issuer FI may store data regarding the cardholder's account and the authorization details including the AAV. In addition, even if the cardholder authentication token is valid, with regard to step 506, if the cardholder's account is overdrawn or otherwise does not support the purchase transaction amount (i.e., the cardholder's available credit is inadequate to cover the total purchase transaction amount), then the issuer FI transmits 514 a purchase transaction denied message to the payment gateway for routing to the merchant server computer, and the process ends. In this case, the issuer FI may store data regarding the cardholder's account and the authorization details including the AAV.

It should be understood that conventional cardholder authentication solutions are not well integrated with transaction authorization messaging, and thus embodiments described herein provide a solution to that shortcoming In particular, the enhanced AAV included with the purchase transaction authorization request provides payment card account issuer financial institutions with enhanced information, in comparison to conventional transaction authorization requests, regarding the type of consumer or cardholder authentication method utilized at the time of the purchase transaction. In addition, the enhanced AAV data advantageously permits merchants and/or issuer financial institutions (FIs) to conduct a review of the performance of their cardholder authentication solutions and/or fraud prevention practices as it applies to fraudulent transaction data.

The processes described herein also advantageously permit merchant acquirer FIs and/or merchants to integrate the enhanced accountholder authentication variable (enhanced AAV) or authentication token into their own risk-based decisioning service process(es). For example, based on past cardholder authentication history and/or prior transaction experiences and/or circumstances, a merchant can make a prediction regarding the likelihood of a similar experience for a current purchase transaction for the cardholder, and thus elect to bypass cardholder authentication processing to speed up and/or facilitate the current purchase transaction. The merchant may also decide to proceed in this manner for purchase transactions involving similar cardholders having payment card accounts within a predetermined range of payment card accounts (i.e., for new consumers and/or customers having the same or similar type of payment card account from the same issuer FI as known cardholders). Thus, a merchant could determine to bypass the cardholder authentication process for a particular cardholder (or group of cardholders) based on the authentication method(s) provided in the enhanced AAV utilized in a past purchase transaction or past purchase transactions for that cardholder and/or group of cardholders.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method for authorizing an online purchase transaction, comprising:
receiving, by a merchant plug-in (MPI) application of a merchant server computer from an issuer access control server (ACS) during an online transaction, a cardholder authentication message comprising an enhanced accountholder authentication variable (AAV) indicative of a type of cardholder authentication;
transmitting, by the MPI application to a payment gateway, a purchase transaction authorization request message including cardholder data, purchase transaction data and the enhanced AAV;
receiving, by the MPI application from the payment gateway, a purchase transaction authorization response message, wherein the purchase transaction authorization response message comprises one of a transaction authorization message or a transaction denied message;
displaying, by the merchant server computer on a merchant webpage, the purchase transaction authorization response message; and
storing, by the MPI application in an MPI database, the purchase transaction authorization response message and the enhanced AAV in association with the cardholder data.

2. The method of claim 1, wherein storing the purchase transaction authorization message and enhanced AAV further comprises storing, by the merchant server computer, the purchase transaction authorization message and enhanced AAV by payment account range in a transaction database utilized for a plurality of cardholders.

3. The method of claim 1, wherein the enhanced AAV indicates one of a silent cardholder authentication process or a step-up authentication cardholder process.

4. The method of claim 1, further comprising:
receiving, by the merchant server computer from a merchant website page, a transaction authorization request comprising cardholder identification data and purchase transaction data for a current online purchase transaction;
retrieving, by the MPI application from the MPI database, stored cardholder purchase transaction data including stored enhanced AAV data based on a match with the cardholder identification data of the current online purchase transaction;
determining, by the MPI application based on the stored enhanced AAV data, to bypass cardholder authentication for the current online purchase transaction; and
transmitting, by the MPI application to a payment gateway, a purchase transaction authorization request including the cardholder identification data and the purchase transaction data for the current online purchase transaction.

5. The method of claim 4, further comprising:
receiving, by the MPI application from the payment gateway, a purchase transaction authorization response message for the current online purchase transaction;
displaying, by the merchant server computer on the merchant webpage, the purchase transaction authorization response message for the current online purchase transaction; and
storing, by the MPI application in the MPI database, the purchase transaction authorization response message for the current online purchase transaction in association with the stored cardholder data.

6. The method of claim 1, further comprising:
receiving, by the merchant server computer from a merchant website page, a transaction authorization request comprising cardholder identification data and purchase transaction data for a current online purchase transaction; retrieving, by the MPI application from the MPI database, stored cardholder purchase transaction data including stored enhanced AAV data based on a match with the cardholder identification data of the current online purchase transaction;
determining, by the MPI application based on the stored enhanced AAV data, that cardholder authentication is required for the current online purchase transaction; and
transmitting, by the MPI application to the ACS, a cardholder authentication request including the cardholder identification data and the purchase transaction data for the current online purchase transaction.

7. The method of claim 6, further comprising:
receiving, by the MPI application from the ACS, a cardholder authentication message comprising an enhanced accountholder authentication variable (AAV) indicative of a type of cardholder authentication;
storing, by the MPI application in the MPI database, the enhanced AAV in association with the cardholder data; and
transmitting, by the MPI application to a payment gateway, a purchase transaction authorization request message including cardholder data, purchase transaction data and the enhanced AAV.

8. The method of claim 1, further comprising:
receiving, by the merchant server computer from a merchant website page, a transaction authorization request comprising cardholder identification data and purchase transaction data for a current online purchase transaction;
determining, by the MPI application based on risk criteria and the purchase transaction data for the current online purchase transaction, that cardholder authentication is required; and
transmitting, by the MPI application to the ACS, a cardholder authentication request including the cardholder identification data and the purchase transaction data for the current online purchase transaction.

9. The method of claim 8, further comprising updating, by the MPI application, criteria for an authentication rules engine based on the stored purchase transaction authorization response message and the enhanced AAV data associated with a plurality of cardholders.

10. An online purchase transaction authorization system, comprising:
a merchant server computer comprising a merchant plug-in (MPI) application;
an MPI database operably connected to the merchant server computer;
an issuer access control server (ACS) operably connected to the merchant server computer; and
a payment gateway operably connected server computer;
wherein the MPI application comprises instructions configured to cause the merchant server computer to:
receive during an online transaction from the ACS, a cardholder authentication message comprising an enhanced accountholder authentication variable (AAV) indicative of a type of cardholder authentication;
transmit a purchase transaction authorization request message including cardholder data, purchase transaction data and the enhanced AAV to the payment gateway;
receive a purchase transaction authorization response message from the payment gateway, wherein the purchase transaction authorization response message comprises one of a transaction authorization message or a transaction denied message;
display the purchase transaction authorization response message on a merchant webpage; and
store the purchase transaction authorization response message and the enhanced AAV in association with the cardholder data in the MPI database.

11. The system of claim 10, wherein the instructions for storing the purchase transaction authorization message and enhanced AAV further comprise instructions configured to cause the merchant server computer to store the purchase transaction authorization message and enhanced AAV by payment account range in a transaction database utilized for a plurality of cardholders.

12. The system of claim 10, further comprising instructions configured to cause the merchant server computer to:
receive a transaction authorization request from a merchant website page, the transaction authorization request comprising cardholder identification data and purchase transaction data for a current online purchase transaction;
retrieve from the MPI database stored cardholder purchase transaction data including stored enhanced AAV data based on a match with the cardholder identification data of the current online purchase transaction;
determine, based on the stored enhanced AAV data, to bypass cardholder authentication for the current online purchase transaction; and
transmit a purchase transaction authorization request to the payment gateway, the purchase transaction authorization request including the cardholder identification data and the purchase transaction data for the current online purchase transaction.

13. The system of claim 12, further comprising instructions configured to cause the merchant server computer to:
receive a purchase transaction authorization response message for the current online purchase transaction from the payment gateway;
display the purchase transaction authorization response message for the current online purchase transaction on the merchant webpage; and
store the purchase transaction authorization response message for the current online purchase transaction in association with the stored cardholder data in the MPI database.

14. The system of claim 10, further comprising instructions configured to cause the merchant server computer to:
receive, from a merchant website page, a transaction authorization request comprising cardholder identification data and purchase transaction data for a current online purchase transaction;
retrieve stored cardholder purchase transaction data from the MPI database, the stored purchase transaction data including stored enhanced AAV data based on a match with the cardholder identification data of the current online purchase transaction;
determine, based on the stored enhanced AAV data, that cardholder authentication is required for the current online purchase transaction; and
transmit a cardholder authentication request to the ACS, the cardholder authentication request including the cardholder identification data and the purchase transaction data for the current online purchase transaction.

15. The system of claim 14, further comprising instructions configured to cause the merchant server computer to:
receive from the ACS, a cardholder authentication message comprising an enhanced accountholder authentication variable (AAV) indicative of a type of cardholder authentication;
store the enhanced AAV in association with the cardholder data in the MPI database; and
transmit a purchase transaction authorization request message including cardholder data, purchase transaction data and the enhanced AAV to a payment gateway.

16. The system of claim 10, further comprising instructions configured to cause the merchant server computer to:
receive from a merchant website page, a transaction authorization request comprising cardholder identification data and purchase transaction data for a current online purchase transaction;
determine, based on risk criteria and the purchase transaction data for the current online purchase transaction, that cardholder authentication is required; and
transmit a cardholder authentication request to the ACS, the cardholder authentication request including the cardholder identification data and the purchase transaction data for the current online purchase transaction.

17. The system of claim 16, further comprising instructions configured to cause the merchant server computer to update criteria for an authentication rules engine based on the stored purchase transaction authorization response message and the enhanced AAV data associated with a plurality of cardholders.
